(19) United States
(12) Patent Application Publication
(10) Pub. No.: US 2016/0265483 A1
(43) Pub. Date: Sep. 15, 2016

(54) Continuous Cude Engine

(71) Applicant: Michael Lewis Moravitz, Fairfax, VA (US)

(72) Inventor: Michael Lewis Moravitz, Fairfax, VA (US)

(21) Appl. No.: 14/998,455

(22) Filed: Jan. 5, 2016

(51) Int. Cl. F02M 26/01

(52) U.S. Cl. CPC F02M 26/01

(57) ABSTRACT

An Internal Combustion Engine in which emissions are recycled through a containment system, some petroleum added back to fuel tank through cooling, and impurities filtered out.

An internal combustion engine can be engineered to have a containment system with near zero emissions. The containment system would have no exhaust pipe, but would recycle the exhaust. Many impurities could be filtered out from the gasoline powered engine, and then a cooling system could condense gaseous petroleum back to its liquid state. This would probably only be a microscopic amount, but could virtually reduce emissions from gasoline-powered vehicles.

The impurities from starting and running the engine can be removed through a more complex filtration system with multiple sections and the filters removed and replaced over time.

1) Builds on patents of latest internal combustion engine designs;

2) Vehicle filtration systems; and

3) Carburetors.
